(19) United States
(12) Patent Application Publication
(10) Pub. No.: US 2025/0369085 A1
(43) Pub. Date: Dec. 4, 2025

(54) METHOD FOR CALCULATING VACUUM CARBURIZING PULSE TIME AND NON-TRANSITORY STORAGE MEDIUM

(71) Applicant: China Academy of Machinery Beijing Research Institute of Mechanical & Electrical Technology, Beijing (CN)

(72) Inventors: Jingbo Ma, Beijing (CN); Jiawei Yao, Beijing (CN); Peiwu Cong, Beijing (CN); Wenlin Lu, Beijing (CN); Chao Jiang, Beijing (CN); Chunhui Du, Beijing (CN); Guangwen Yang, Beijing (CN); Danruo Xue, Beijing (CN); Longxiang He, Beijing (CN)

(21) Appl. No.: 19/299,169

(22) Filed: Aug. 13, 2025

Related U.S. Application Data
(63) Continuation-in-part of application No. PCT/CN2024/138319, filed on Dec. 11, 2024.

(30) Foreign Application Priority Data
May 14, 2024 (CN) 202410594549.1

(51) Int. Cl. C23C 8/22

(52) U.S. Cl. CPC C23C 8/22

(57) ABSTRACT

The present invention provides a method for calculating vacuum carburizing pulse time and a non-transitory storage medium. The method includes: determining a target surface carbon concentration, a target carburized carbon mass m_{d}, material parameters, a number of carburizing pulses, a left value C_{l,l} of a target surface carbon concentration low point, a right value C_{l,r} of the target surface carbon concentration low point, and an error E; obtaining a carburized carbon mass mₗ at C_{l,l} until mₗ≥m_{d}; obtaining a carburized carbon mass mᵣ at C_{l,r}until mᵣ≤m_{d}; calculating C_{l,m}; and obtaining carburized carbon mass mₘ at C_{l,m} and a sum of boost time and diffusion time of all carburizing pulses, when |mₘ−m_{d}|≤E, the sum of the boost time and diffusion time of all the carburizing pulses is pulse time.

### CROSS REFERENCE TO RELATED APPLICATION(S)

This application is a continuation-in-part application of International Patent Application No. PCT/CN2024/138319, filed on Dec. 11, 2024, which claims priority to Chinese Patent Application No. 202410594549.1, filed on May 14, 2024 and entitled “METHOD FOR CALCULATING VACUUM CARBURIZING PULSE TIME AND NON-TRANSITORY STORAGE MEDIUM”, both of which are incorporated herein by reference in their entities.

### TECHNICAL FIELD

The present invention relates to the technical field of vacuum carburizing, and in particular to a method for calculating vacuum carburizing pulse time and a non-transitory storage medium.

### BACKGROUND

Vacuum low-pressure carburizing is a clean, efficient, and green surface strengthening technology with a wide range of applications in fields such as aerospace, rail transit, automobiles and industrial robots. With the development of the vacuum low-pressure carburizing technology, a carburizing method has gradually evolved from traditional “one-stage” or “two-stage” to a “pulse” method. Pulse carburizing involves periodic “inflation-pressure maintenance-evacuation-pressure maintenance” in a carburizing process. Compared with the “one-stage” or “two-stage” carburizing, the pulse carburizing can reduce the generation of carbon black and achieve refined control of the carburizing process.

From the perspective of microscopic mechanism, for one pulse, the “inflation-pressure maintenance-evacuation” is usually called as a boost process, and the subsequent “pressure maintenance” is called as a diffusion process. In the boost process, carbon concentration in a material is increased by supplying a carburizing medium, and the carbon concentration at surfaces reaches a peak point; in the diffusion process, the carbon concentration at material surfaces decreases by the diffusion of carbon in the material, and the carbon concentration at the surfaces reaches a low point. Apparently, boost time and diffusion time are important process parameters to ensure that a carburized workpiece reaches a target carbon concentration distribution, and are also core parameters to be calculated in the vacuum carburizing process.

A carburized mass is an important integral quantity of the vacuum carburizing process, and may be used as a carburizing target like carburized layer depth. The carburized mass may be measured by using a weight difference method, which is convenient and does not damage the workpiece. Additionally, an amount of carbon required to be provided by the carburizing medium is linearly related to the carburized mass of carbon. However, there is currently no method to calculate a carburizing process (a time sequence of a boost-diffusion process) with the carburized mass as a carburizing target. The current algorithm with the carburized layer depth as a calculation target has insufficient calculation accuracy of around 5%.

### SUMMARY

The purpose of the present invention is to provide a method for calculating vacuum carburizing pulse time and a non-transitory storage medium. The calculation method provided in the present invention has small errors.

In order to achieve the aforementioned objective, the present invention provides the following technical solutions.

The present invention provides a method for calculating vacuum carburizing pulse time, including the steps of:
(1) determining a target surface carbon concentration C_{d}, a target carburized carbon mass m_{d}, material parameters, the number of carburizing pulses n, a left value C_{l,l} of a target surface carbon concentration low point, a right value C_{l,r} of the target surface carbon concentration low point, and an error E, where a matrix carbon concentration<C_{l,l}<C_{l,r}<an austenite saturated carbon concentration;
(2) obtaining, according to C_{d}, the material parameters, n, and C_{l,l}, a carburized carbon mass mₗ when the surface carbon concentration low point is C_{l,l}, when mₗ<m_{d}, reducing C_{l,l} and repeating step (2) until mₗ≥m_{d}; and
   when mₗ≥m_{d}, proceeding to step (3);
(3) obtaining, according to C_{d}, the material parameters, n, and C_{l,r}, a carburized carbon mass mᵣ when the surface carbon concentration low point is C_{l,r}, when mᵣ>m_{d}, increasing C_{l,r} and repeating step (3) until mᵣ≤m_{d}; and
   when mᵣ≤m_{d}, proceeding to step (4);
(4) calculating C_{l,m} according to a corresponding C_{l,l} when mₗ≥m_{d}in step (2) and a corresponding C_{l,r} when mᵣ>m_{d}in step (3), where C_{l,m} =xC_{l,l}+(l−x)C_{l,r}, where 0<x<1; and
(5) obtaining carburized carbon mass mₘ at C_{l,m} and a sum of boost time and diffusion time of all carburizing pulses according to C_{d}, the material parameters, n, and the surface carbon concentration low point C_{l,m}, where
   when |mₘ−m_{d}|≤E, C_{l,m} is the surface carbon concentration low point, and the sum of the boost time and diffusion time of all the carburizing pulses is pulse time;
   when |mₘ−m_{d}|>E and mₘ≤m_{d}, C_{l,l}=C_{l,m}, and steps (4) and (5) are repeated until |mₘ−m_{d}|≤E; and
   when |mₘ−m_{d}|>E and mₘ<m_{d}, C_{l,r}=C_{l,m}, and steps (4) and (5) are repeated until |mₘ−m_{d}|≤E.

In one embodiment, the material parameters includes a surface transfer coefficient, a diffusion coefficient, and a matrix carbon content.

In one embodiment, a difference between C_{l,l} and the matrix carbon concentration is 0.1 wt %.

In one embodiment, a difference between the austenite saturated carbon concentration and C_{l,r} is 0.1 wt %.

In one embodiment, the error E is 1e⁻⁶ kg/m².

In one embodiment, a calculation method of the carburized mass m, the boost time, and the diffusion time in steps (2), (3), and (5) includes solving a Fick's law by a finite difference method, a finite element method, or an analytical equation method.

The present invention further provides a non-transitory storage medium storing a computer program for executing the calculation method in the foregoing technical solutions of the claim.

The method for calculating vacuum carburizing pulse time provided by the present invention has the following technical effects:
(1) Fine control of carbon concentration during carburizing is a basis for regulating the structure and properties of a carburized part. The present invention uses a carburized mass as a carburizing target, and thus can accurately calculate time of all boost processes and diffusion processes of vacuum carburizing in the case of a fixed number of pulses. An error between a carburized mass of a workpiece obtained based on the aforementioned vacuum carburizing pulse time and a target value is less than 0.1%, which is a significant improvement compared to a calculation error of 5% of a traditional algorithm (a current algorithm that uses the depth of a carburized layer as a calculation target), thereby providing process method support for refined control of carburizing processes.
(2) Carburizing needs to be carried out at high temperatures and thus is a process with high energy consumption. A carburized mass calculated by traditional methods is often higher than a target carburized mass. The higher the carburized mass, the greater a deviation value, and the longer calculated process time. The deviation value of the present invention is relatively low, which can avoid the aforementioned problems, and can not only reduce process time and improve carburizing efficiency, but also can reduce insulation time of the workpiece at a carburizing temperature, thereby reducing energy consumption.
(3) In the traditional calculation method, the number of carburizing pulses cannot be adjusted. The number of pulses in the present invention is preset. By changing the number of pulses, time for all boost and diffusion processes of different vacuum carburizing may be obtained. The present invention may obtain a corresponding pulse carburizing process time for vacuum carburizing equipment by adjusting the number of pulses. Therefore, the present invention has stronger adjustability in an actual carburizing apparatus and process operation, and is more in line with actual production needs.

### BRIEF DESCRIPTION OF THE DRAWINGS

FIG. 1 is a flow chart of a calculation method in an embodiment of the present invention;

FIG. 2 shows a variation tendency of C_{l,m} as an increase in the number of cycles during a calculation process;

FIG. 3 shows a variation tendency of a carburized mass as an increase in the number of cycles during a calculation process; and

FIG. 4 is a diagram showing carburizing time when different numbers of pulses are used.

### DETAILED DESCRIPTION OF THE EMBODIMENTS

The present invention provides a method for calculating vacuum carburizing pulse time, including the following steps:
(1) determining a target surface carbon concentration C_{d}, a target carburized carbon mass m_{d}, material parameters, the number of carburizing pulses n, a left value C_{l,l} of a target surface carbon concentration low point, a right value C_{l,r} of the target surface carbon concentration low point, and an error E, where a matrix carbon concentration<C_{l,l}<C_{l,r}<an austenite saturated carbon concentration;
(2) obtaining, according to C_{d}, the material parameters, n, and C_{l,l}, a carburized carbon mass mₗ when the surface carbon concentration low point is C_{l,l}; when mₗ<m_{d}, reducing C_{l,l} and repeating step (2) until mₗ≥m_{d}; and
   when mₗ≥m_{d}, proceeding to step (3);
(3) obtaining, according to C_{d}, the material parameters, n, and C_{l,r}, a carburized carbon mass m, when the surface carbon concentration low point is C_{l,r}; when mᵣ>m_{d}, increasing C_{l,r} and repeating step (3) until mᵣ≤m_{d}; and
   when mᵣ≤m_{d}, proceeding to step (4);
(4) calculating C_{l,m} according to a corresponding C_{l,l} when mₗ≥m_{d} in step (2) and a corresponding C_{l,r} when mᵣ≤m_{d} in step (3), where
   C_{l,m}=xC_{l,l}+(1−x)C_{l,r}, where 0<x<1; and
(5) obtaining carburized carbon mass mₘ at C_{l,m} and a sum of boost time and diffusion time of all carburizing pulses according to C_{d}, the material parameters, n, and the surface carbon concentration low point C_{l,m}, where
   when |mₘ−m_{d}|≤E, C_{l,m} is the surface carbon concentration low point, and the sum of the boost time and diffusion time of all the carburizing pulses is pulse time;
   when |mₘ−m_{d}|>E and mₘ>m_{d}, C_{l,l}=C_{l,m}, and steps (4) and (5) are repeated until |mₘ−m_{d}|≤E; and
   when |mₘ−m_{d}|>E and mₘ<m_{d}, C_{l,r}=C_{l,m}, and steps (4) and (5) are repeated until |mₘ−m_{d}|≤E.
(1) The target surface carbon concentration C_{d}, the target carburized carbon mass m_{d}, the material parameters, the number of carburizing pulses n, the left value C_{l,l} of the target surface carbon concentration low point, the right value C_{l,r} of the target surface carbon concentration low point, and the error E are determined.

In the present invention, a matrix carbon concentration<C_{l,l}<C_{l,r}<an austenite saturated carbon concentration. In one embodiment, a difference between C_{l,l} and the matrix carbon concentration is 0.1 wt %.

In one embodiment, a difference between the austenite saturated carbon concentration and C_{l,r} is 0.1 wt %.

In one embodiment, the material parameters include a surface transfer coefficient, a diffusion coefficient, and a matrix carbon content.
(2) The carburized carbon mass mₗ when the surface carbon concentration low point is C_{l,l}, is obtained according to C_{d}, the material parameters, n, and C_{l,l}, and when mₗ<m_{d}, C_{l,l} is reduced and step (2) is repeated until mₗ≥m_{d};
   when mₗ≥m_{d}, step (3) is performed.

In the present invention, the reduced C_{l,l} still needs to meet the requirement that the matrix carbon concentration<C_{l,l}<C_{l,r}<the austenite saturated carbon concentration.
(3) The carburized carbon mass mᵣ when the surface carbon concentration low point is C_{l,r}, is obtained according to C_{d}, the material parameters, n, and C_{l,r}; when mᵣ>m_{d}, C_{l,r} is increased and step (3) is repeated until mᵣ≤m_{d}; and
   when mᵣ≤m_{d}, step (4) is performed.

In the present invention, the increased C_{l,r} still needs to meet the requirement that the matrix carbon concentration<C_{l,l}<C_{l,r}<the austenite saturated carbon concentration.
(4) C_{l,m} is calculated according to the corresponding C_{l,l} when mₗ≥m_{d} in step (2) and the corresponding C_{l,r} when mᵣ≤m_{d} in step (3), where
   C_{l,m}=xC_{l,l}+ (1−x)C_{l,r}, where 0<x<1, and in one embodiment x is ½.
(5) The carburized carbon mass mₘ at C_{l,m} and the sum of boost time and diffusion time of all carburizing pulses are obtained according to C_{d}, the material parameters, n, and the surface carbon concentration low point C_{l,m}.
   When |mₘ−m_{d}|E, C_{l,m} is the surface carbon concentration low point, and the sum of the boost time and diffusion time of all the carburizing pulses is pulse time.
   When |mₘ−m_{d}|>E and mₘ>m_{d}, C_{l,l}=C_{l,m}, and steps (4) and (5) are repeated until |mₘ−m_{d}|≤E.
   When |mₘ−m_{d}|>E and mₘ<m_{d}, C_{l,r}=C_{l,m}, and steps (4) and (5) are repeated until |mₘ−m_{d}|≤E.

In one embodiment, a calculation method of the carburized carbon mass m in steps (2), (3), and (5) includes solving the Fick's law by a finite difference method, a finite element method, or an analytical equation method to calculate a carbon concentration distribution after carburizing, and in another embodiment it is the calculation method in publication number CN116564452A.

The present invention further provides a non-transitory storage medium storing a computer program for executing the calculation method described in the foregoing solutions.

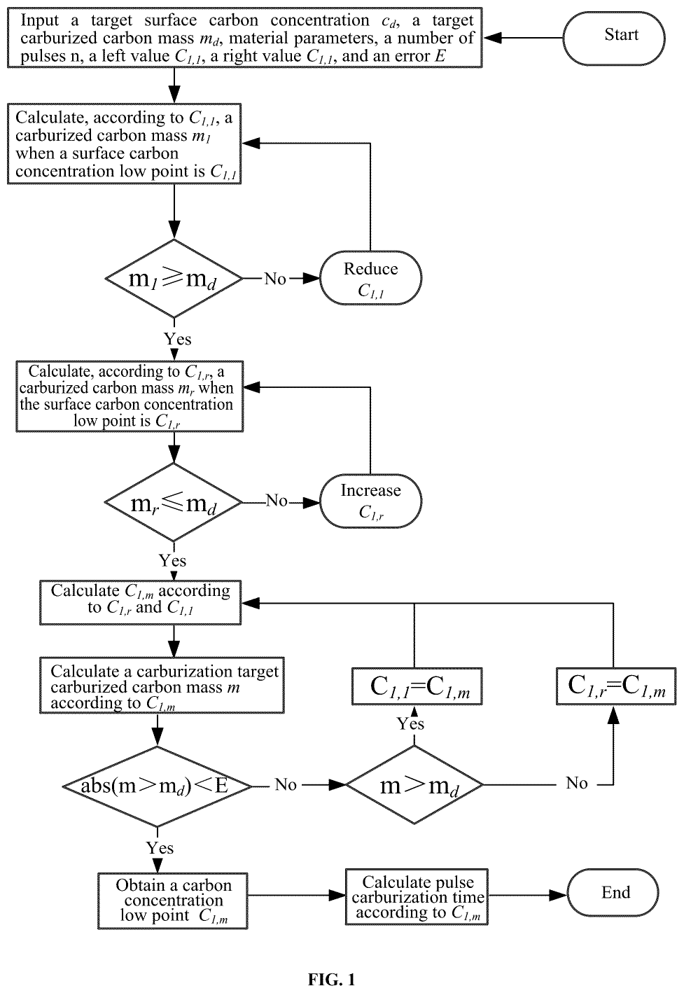

A flow chart of the calculation method in an embodiment of the present invention is shown in FIG. 1.

The following is a detailed description of a method for calculating vacuum carburizing pulse time and a non-transitory storage medium provided by the present invention in conjunction with embodiments, but they should not be construed as limiting the protection scope of the present invention.

### Embodiment 1

The target surface carbon concentration is 0.8 wt %. The target carbon carburized mass is 0.019 kg/m². Parameters of a matrix material are as follows: the surface transfer coefficient is 5×10⁻⁸ m/s, the diffusion coefficient is 1×10⁻¹¹ m²/s, the austenite saturated carbon concentration is 1.6 wt %, the matrix carbon concentration is 0.2 wt %, and the density is 7.8×10³ kg/m³. The number of carburizing pulses is 10, the left value is 0.3 wt %, the right value is 1.5 wt %, and the error is 1e⁻⁶ kg/m². Carburizing gas is Acetylene.
(1) The target surface carbon concentration C_{d}, the target carburized carbon mass m_{d}, the material parameters, the number of carburizing pulses n, the left value C_{l,l} of the target surface carbon concentration low point, the right value C_{l,r} of the target surface carbon concentration low point, and the error E are determined, where the matrix carbon concentration<C_{l,l}<C_{l,r}<the austenite saturated carbon concentration.
(2) The carburized carbon mass mₗ when the surface carbon concentration low point is C_{l,l} is obtained according to C_{d}, the material parameters, n, and C_{l,l}, when mₗ<m_{d}, C_{l,l} is reduced and step (2) is repeated until mₗ≥m_{d}; and
   when mₗ≥m_{d}, step (3) is performed.
(3) The carburized carbon mass mᵣ when the surface carbon concentration low point is C_{l,r}, is obtained according to C_{d}, the material parameters, n, and C_{l,r}, when mₗ≥m_{d}, C_{l,r} is increased and step (3) is repeated until mᵣ≤m_{d}; and
   when mᵣ≤m_{d}, step (4) is performed.
(4) C_{l,m} is calculated according to the corresponding C_{l,l} when mₗ≥m_{d} in step (2) and the corresponding C_{l,r} when mₗ≤m_{d} in step (3), where

$${C}_{1 , m} = ( {C}_{1 , 1} + {C}_{1 , r} ) / 2.$$

(5) The carburized carbon mass mₘ at C_{l,m} and the sum of boost time and diffusion time of all carburizing pulses are obtained according to C_{d}, the material parameters, n, and the surface carbon concentration low point C_{l,m}.
   When |mₘ−m_{d}|≤E, C_{l,m} is the surface carbon concentration low point, and the sum of the boost time and diffusion time of all the carburizing pulses is pulse time.
   When |mₘ−m_{d}|>E and mₗ>m_{d}, C_{l,l}=C_{l,m}, and steps (4) and (5) are repeated until |mₘ−m_{d}|≤E.

When |mₘ−m_{d}|>E and mₗ<m_{d}, C_{l,r}=C_{l,m}, and steps (4) and (5) are repeated until |mₘ−m_{d}|≤E.

A method for calculating the vacuum carburizing pulse time according to C_{d}, the material parameters, n, and C_{l,m} (C_{l,r} or C_{l,l}) includes the following steps 1-4.

Step 1: for a boost process, the carburizing time is assumed to be t (t>0), the Fick's law is solved by using the finite difference method to obtain a surface carbon concentration when the carburizing time is t. If the surface carbon concentration is lower than the austenite saturation carbon concentration, t is increased. If the surface carbon concentration is higher than the austenite saturation carbon concentration, t is reduced. The above process is repeated until time t₁ when the surface carbon concentration of a workpiece reaches the austenite saturation carbon concentration in the boost process is obtained, and a carbon concentration distribution when the carburizing time is t₁ is obtained, by solving the Fick's law, as an initial value of a carbon concentration distribution in a next process.

Step 2: for a diffusion process, the carburizing time is assumed to be t, the Fick's law is solved by using the finite difference method to obtain a surface carbon concentration when the carburizing time is t. If the surface carbon concentration is higher than the pulse carburizing surface carbon concentration low point C_{l,m}, t is increased. If the surface carbon concentration is lower than the pulse carburizing surface carbon concentration low point C_{l,m}, t is reduces. The above process is repeated until time t₂ when the surface carbon concentration of the workpiece reaches the pulse carburizing surface carbon concentration low point C_{l,m} in the diffusion process is obtained, and a carbon concentration distribution when the carburizing time is t₂ is obtained, by solving the Fick's law, as an initial value of a carbon concentration distribution in a next process.

Step 3: step 1 and step 2 are repeated eight times to obtain t₃ to t₁₈, and then step 1 is perform again to obtain t₁₉.

Step 4: the carburizing time is assumed to be t, the Fick's law is solved by using a finite difference method to obtain a surface carbon concentration when the carburizing time is t. If the surface carbon concentration is higher than C_{d}, t is increased. If the surface carbon concentration is lower than C_{d}, t is reduced. The above process is repeated until time t₂₀ when the surface carbon concentration is C_{d} is obtained and a carbon concentration distribution when the carburizing time is t₂₀ is obtained by solving the Fick's law. Integral calculation is performed based on the carbon concentration distribution to obtain the carburized mass m. The time t₁ to t₂₀ recorded in all the previous steps is the pulse carburizing time.

The final pulse carburizing time obtained is as follows:

TABLE 1
Pulse carburizing time in Embodiment 1

| Process | | |
|---|---|---|
| number | Carburizing process type | Time (s) |
| t₁ | Boost process | 216 |
| t₂ | Diffusion process | 204 |
| t₃ | Boost process | 86.6 |
| t₄ | Diffusion process | 329.1 |
| t₅ | Boost process | 80.2 |
| t₆ | Diffusion process | 453.4 |
| t₇ | Boost process | 77.5 |
| t₈ | Diffusion process | 579.1 |
| t₉ | Boost process | 76.1 |
| t₁₀ | Diffusion process | 706.5 |
| t₁₁ | Boost process | 75.3 |
| t₁₂ | Diffusion process | 835.5 |
| t₁₃ | Boost process | 74.7 |
| t₁₄ | Diffusion process | 965.8 |
| t₁₅ | Boost process | 74.3 |
| t₁₆ | Diffusion process | 1097.4 |
| t₁₇ | Boost process | 74 |
| t₁₈ | Diffusion process | 1230.2 |
| t₁₉ | Boost process | 73.8 |
| t₂₀ | Diffusion process | 3344 |

### Result Analysis:

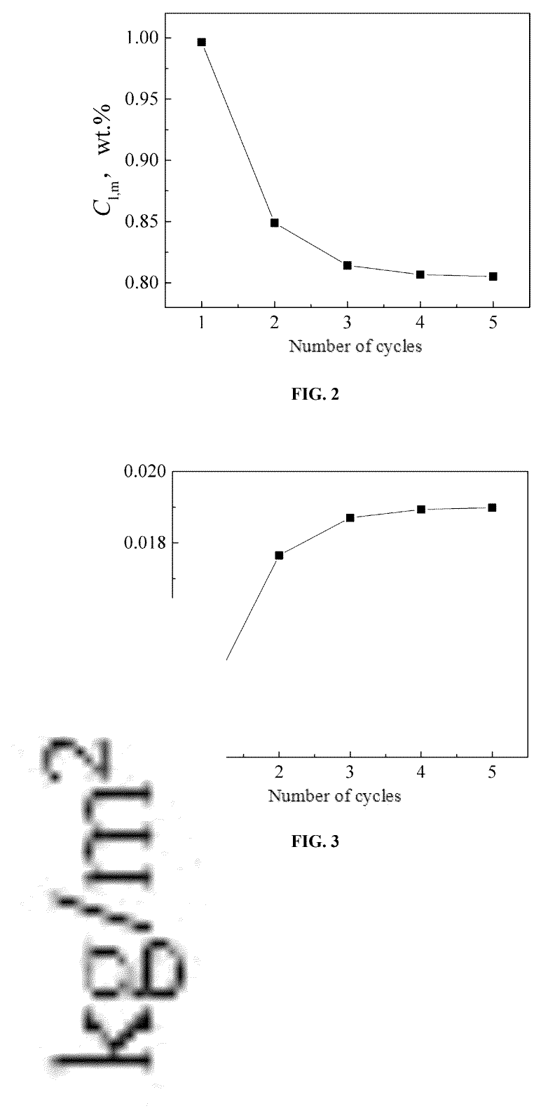

FIG. 2 and FIG. 3 respectively show variation tendency of C_{l,m} and the carburized mass as an increase in the number of cycles during a calculation process. It can be seen from the figures that with the increase in the number of cycles, the carburized mass continues to approach the target carburized mass. Finally, the error therebetween is less than E, and a condition for ending the algorithm is met, and an optimal C_{l,m} is obtained. The pulse carburizing time may then be calculated based on C_{l,m}.

In this embodiment, when the target carburized mass is 0.019 kg/m², the carburized mass calculated by using a traditional algorithm is 0.0203 kg, where the error is 6%, and the total carburizing time is 202 min, while the carburized mass obtained by the method of the present invention is 0.01899 kg, where the error is 0.052%, and the total carburizing time is 177 min. Compared with the traditional algorithm, the process time calculated by the method in the present invention is shortened by 12.4%, effectively improving process efficiency.

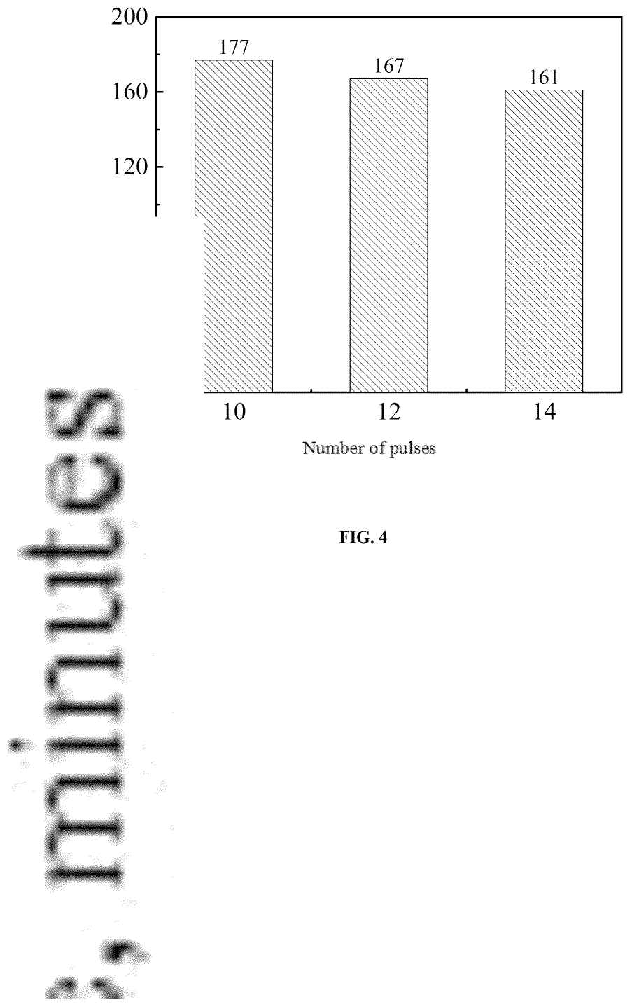

FIG. 4 is a diagram showing carburizing time when different numbers of pulses are used. It can be seen that as the number of pulses set during calculation of the process increases, the process time is gradually shortened. The higher the number of pulses is, the shorter the boost time is, and the higher requirements for inflation, pressure maintenance, and pumping rates of an apparatus are. Therefore, the number of pulses may be determined according to actual conditions of the apparatus.

The terms “vacuum carburizing” and “vacuum low-pressure carburizing” herein both refer to “low-pressure carburizing”, and the term “pulse carburizing” refers to “low-pressure carburizing in pulsed mode”. The foregoing descriptions are merely preferred embodiments of the present invention, and it should be noted that for those skilled in the art, without departing from the principles of the present invention, some improvements and refinement may also be made, which should also be considered as the protection scope of the present invention.

What is claimed is:

1. A method for calculating vacuum carburizing pulse time, comprising:
(1) determining a target surface carbon concentration C_{d}, a target carburized carbon mass m_{d}, material parameters, a number of carburizing pulses n, a left value C_{l,l} of a target surface carbon concentration low point, a right value C_{l,r} of the target surface carbon concentration low point, and an error E, wherein a matrix carbon concentration<C_{l,l}<C_{l,r}<an austenite saturated carbon concentration;
(2) obtaining, according to C_{d}, the material parameters, n, and C_{l,l}, a carburized carbon mass mₗ when the surface carbon concentration low point is C_{l,l}, when mₗ<m_{d}, reducing C_{l,l} and repeating step (2) until mₗ≥m_{d}; and
when mₗ≥m_{d}, proceeding to step (3);
(3) obtaining, according to C_{d}, the material parameters, n, and C_{l,r}, a carburized carbon mass mᵣ when the surface carbon concentration low point is C_{l,r}, when mᵣ>m_{d}, increasing C_{l,r} and repeating step (3) until mᵣ≤m_{d}; and
when mᵣ≤m_{d}, proceeding to step (4);
(4) calculating C_{l,m} according to a corresponding C_{l,l} when mₗ≥m_{d} in step (2) and a corresponding C_{l,r} when mᵣ<m_{d} in step (3), wherein
C_{l,m}=xC_{l,l}+(1−x) C_{l,r}, wherein 0<x<1; and
(5) obtaining carburized carbon mass mₘ at C_{l,m} and a sum of boost time and diffusion time of all carburizing pulses according to C_{d}, the material parameters, n, and the surface carbon concentration low point C_{l,m}, wherein
when |mₘ−m_{d}|≤E, C_{l,m} is the surface carbon concentration low point, and the sum of the boost time and diffusion time of all the carburizing pulses is pulse time;
when |mₘ−m_{d}|>E and mₘ>m_{d}, C_{l,l}=C_{l,m}, and steps (4) and (5) are repeated until |mₘ−m_{d}|≤E; and
when |mₘ−m_{d}|>E and mₘ<m_{d}, C_{l,r}=C_{l,m} and steps (4) and (5) are repeated until |mₘ−m_{d}|≤E.

2. The method according to claim 1, wherein the material parameters comprise a surface transfer coefficient, a diffusion coefficient, and a matrix carbon content.

3. The method according to claim 1, wherein a difference between C_{l,l} and the matrix carbon concentration is 0.1 wt %.

4. The method according to claim 1, wherein a difference between the austenite saturated carbon concentration and C_{l,r} is 0.1 wt %.

5. The method according to claim 1, wherein the error E is 1e⁻⁶ kg/m².

6. The method according to claim 1, wherein a calculation method of the carburized carbon mass m, the boost time, and the diffusion time in steps (2), (3), and (5) comprises solving a Fick's law by a finite difference method, a finite element method, or an analytical equation method.

7. The method according to claim 1, wherein x is ½.

8. A non-transitory storage medium storing a computer program for executing the method according to any one of claim 1.

9. The non-transitory storage medium according to claim 8, wherein the material parameters comprise a surface transfer coefficient, a diffusion coefficient, and a matrix carbon content.

10. The non-transitory storage medium according to claim 8, wherein a difference between C_{l,l} and the matrix carbon concentration is 0.1 wt %.

11. The non-transitory storage medium according to claim 8, wherein a difference between the austenite saturated carbon concentration and C_{l,r} is 0.1 wt %.

12. The non-transitory storage medium according to claim 8, wherein the error E is 1e⁻⁶ kg/m².

13. The non-transitory storage medium according to claim 8, wherein a calculation method of the carburized carbon mass m, the boost time, and the diffusion time in steps (2), (3), and (5) comprises solving a Fick's law by a finite difference method, a finite element method, or an analytical equation method.

14. The non-transitory storage medium according to claim 8, wherein x is ½.
